(19) United States
(12) Patent Application Publication
(10) Pub. No.: US 2026/0304179 A1
(43) Pub. Date: Oct. 1, 2026

(54) SYSTEMS AND METHODS FOR AUTOMATING ANCHOR RELATIONSHIP DETERMINATION IN A WIRELESS NETWORK

(71) Applicant: Verizon Patent and Licensing Inc., Basking Ridge, NJ (US)

(72) Inventors: Francisco Xavier SEVILLA RUBI, Eden Prairie, MN (US); John P. HAMAN, Chester, SD (US); James T. STEWART, Syracuse, NE (US); Jeremy J. WINKELMAN, Scottsdale, AZ (US)

(73) Assignee: Verizon Patent and Licensing Inc., Basking Ridge, NJ (US)

(21) Appl. No.: 19/091,298

(22) Filed: Mar. 26, 2025

(51) Int. Cl. H04W 24/10; H04W 76/15

(52) U.S. Cl. CPC H04W 24/10; H04W 76/15

(57) ABSTRACT

In some implementations, a network management system may receive one or more measurement reports from one or more user equipments (UEs), each measurement report of the one or more measurement reports including one or more metrics that characterize a network. The network management system may generate a data structure of one or more anchor relationships between cells in the network for dual connectivity (DC), the one or more anchor relationships based at least in part on the one or more measurement reports. The network management system may utilize the data structure to manage DC in the network.

### BACKGROUND

In the realm of telecommunications, dual connectivity (DC) may be used to optimize network performance and enhance user experience. As an example of DC, a user equipment (UE) may maintain simultaneous connections to two different base stations to increase data throughput and increase connection reliability. The first base station may function as a master node that provides a primary connection and control functions to the UE, and the second base station may function as a secondary connection that is managed by the first base station.

### BRIEF DESCRIPTION OF THE DRAWINGS

FIGS. 1A-1F are diagrams of an example implementation associated with automated dual connectivity management within wireless networks.

FIG. 2 is a diagram of an example environment 200 in which systems and/or methods described herein may be implemented.

FIG. 3 is a diagram of example components of a device associated with automating anchor relationship determination in a wireless network.

FIG. 4 is a flowchart of an example process associated with automating anchor relationship determination in wireless networks.

### DETAILED DESCRIPTION OF EXAMPLE EMBODIMENTS

The following detailed description of example implementations refers to the accompanying drawings. The same reference numbers in different drawings may identify the same or similar elements.

The concept of dual connectivity (DC) plays a pivotal role in optimizing network performance and enhancing user experience. In DC, a user equipment (UE) maintains simultaneous connections to two different base stations (alternatively referred to as cells), for example, a Long Term Evolution (LTE) base station and a New Radio (NR) base station in an evolved universal terrestrial radio access network-NR dual connectivity (EN-DC) configurations, or two NR base stations (e.g., two NR base stations operating in different frequency bands) in NR-DC configurations. One of these base stations functions as a master node (e.g., a master base station or a master cell) that provides a primary connection and control functions to the UE. In some cases, the master node may also be referred to as an “anchor.”

“Anchoring relationship” denotes a relationship between a master node and a secondary node (e.g., a secondary base station or a secondary cell) for DC, and the base stations selected to act as the master node and the secondary node may be based at least in part on a variety of parameters. An anchoring relationship in a wireless network may involve defining a logical link between a master node, such as an LTE base station or NR base station, and a secondary node. The anchoring relationship may be characterized in a data structure (e.g., a database) using one or more of the parameters, such as an NR cell global identity (NCGI) of a master node, an NCGI of a secondary node, a type of dual connectivity (EN-DC or NR-DC), a public land mobile network (PLMN), a distance (e.g., geographical coordinates or network topology information), or subcarrier spacing (e.g., for the master node and/or the secondary node). A PLMN may indicate a network that is established and operated by an authorized entity providing wireless communication services to the public and may be identified by a unique identifier. Managing anchoring relationships between a master node and a secondary node can be a complex and labor-intensive process that involves manually entering data into the data structure, such as by generating and storing information about multiple potential combinations of cells and respective anchoring relationship details, including the creation of one-to-one or one-to-many mappings between potential master nodes and potential secondary nodes. Current methodologies, such as using distance or subcarrier spacing to select an anchor or master node, fall short in capturing the intricate dynamics of wireless networks. For example, the current methodologies may not account for the myriad of factors influencing optimal anchoring decisions, including signal strength, channel conditions, and the specific characteristics of cells in different frequency bands, such as C-band (e.g., a frequency range of 4 gigahertz (GHz) to 8 GHz) and mmWave (e.g., a frequency range of 24 GHz to 100 GHz). As a result, network operators face challenges in efficiently and effectively managing anchor relationships, leading to suboptimal connectivity experiences. Additionally, the absence of a mechanism that automatically updates anchoring relationships (e.g., the information about anchoring relationships in a data structure) based on dynamic changes in the network represents a significant gap in current network management practices, particularly as channel conditions within a network change, resulting in obsolete anchoring relationship information in the data structure.

Some implementations described herein provide a method for automated anchoring relationship management within a wireless network through the employment of a network management system that utilizes measurement reports from UEs to inform network configurations. Specifically, the network management system receives measurement reports containing network-related metrics or network-related identifiers, such as reference signal received power (RSRP), reference signal received quality (RSRQ), interference levels, and physical cell identity (PCI). RSRP may provide a measurement metric of a power level of one or more reference signals (e.g., that are received by a UE from a cell in a wireless network) and may be used to determine signal strength. RSRQ may provide a measurement metric that combines both signal strength and signal quality, calculated as the ratio of RSRP to a total received power of a carrier, and may be used to assess the quality of a wireless link. PCI is a unique identifier assigned to each cell in a wireless network and allows a UE to distinguish between different cells. Utilizing these metrics and identifiers, the network management system may generate or populate a data structure with information that delineates anchor relationships between potential master nodes (e.g., potential anchors) and potential secondary nodes for various DC configurations (e.g., EN-DC or NR-DC), resulting in automated management of DC within the network infrastructure that is based on current network conditions. The network management system may receive and use additional measurement reports to refine and optimize the anchor relationship information over time, thereby mitigating the obsolescence of the stored information in a dynamically changing network environment.

By using measurement reports from UEs and automating the process of generating and updating anchor relationships, a network management system may efficiently capture the true complexity of a network and identify anchor relationships that may increase the efficiency of DC and the efficiency of maintaining up-to-date anchor relationships. To illustrate, anchoring relationships that are based at least in part on measurement reports from UEs may lead to more accurate network configurations based at least in part on using current measurement metrics that characterize channel conditions within the network, may reduce resource waste, may increase data throughput, may reduce data transfer latencies, and may reduce an overhead that is associated with manual planning. By automating the establishment and maintenance of DC relationships, the network management system conserves processing resources, memory resources, network resources, and/or the like, enables more efficient utilization of network infrastructure, and facilitates improved network management and reliability. That is, the automation of generating and updating anchor relationship information through real-time UE measurements significantly decreases the need for manual interventions and captures the dynamic nature of the network topology. This automation may also enable the network management system to swiftly adapt to variations in network conditions and user demand, ensuring that the management of DC remains efficient and technically robust. Examples of efficient and robust DC connections may include reduced latency in data updates, enhanced accuracy in DC management, and optimized utilization of network resources. Additionally, or alternatively, the network management system may conserve processing resources, memory resources, network resources, and/or the like, by automating and optimizing DC management tasks that were previously manual and error-prone.

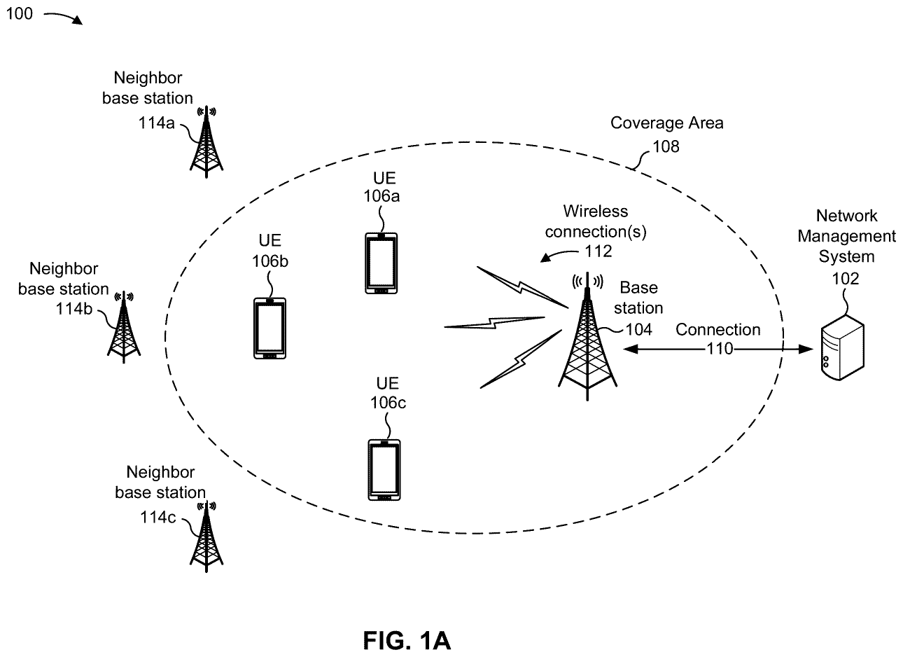

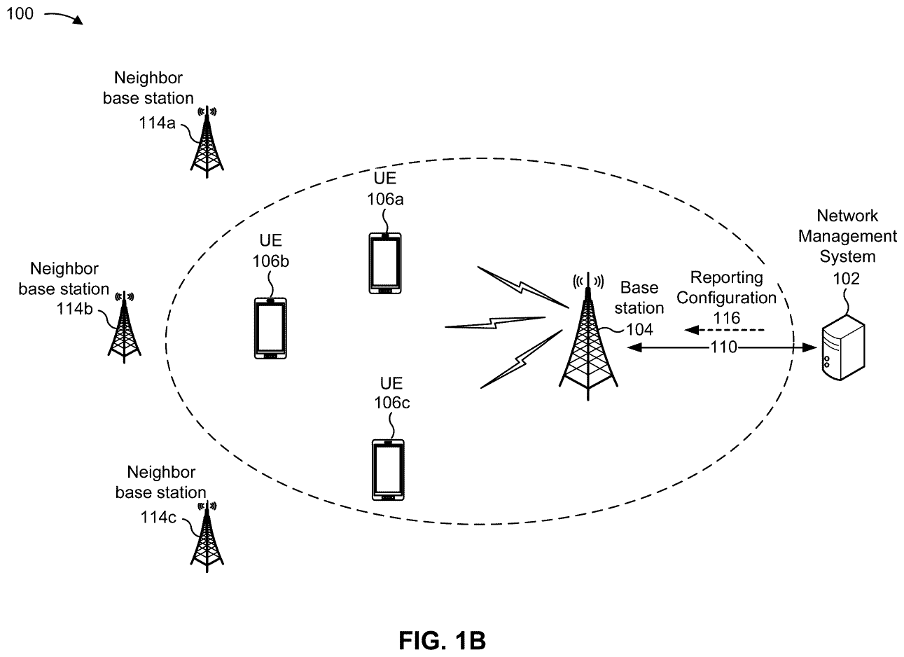

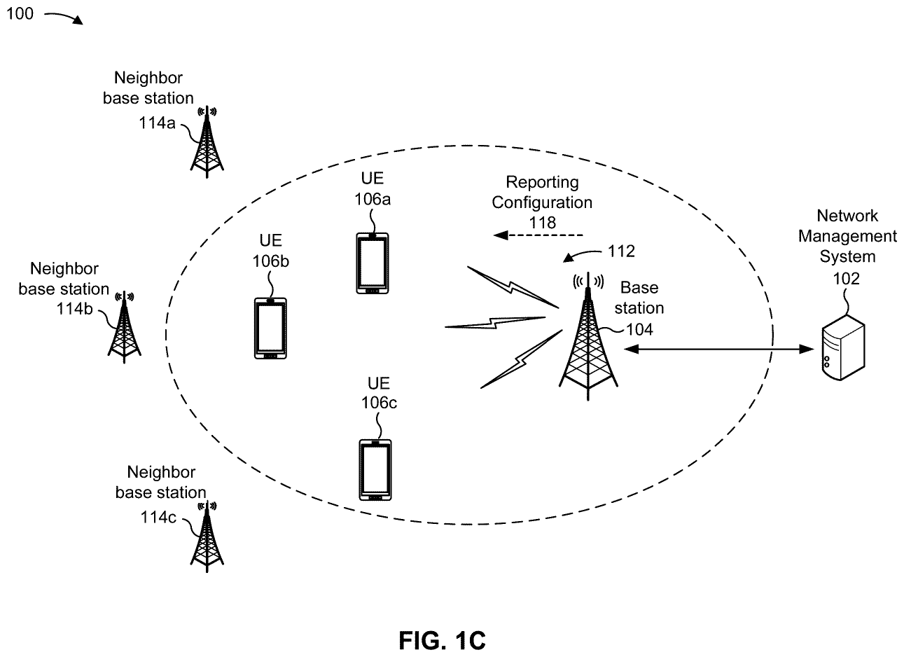

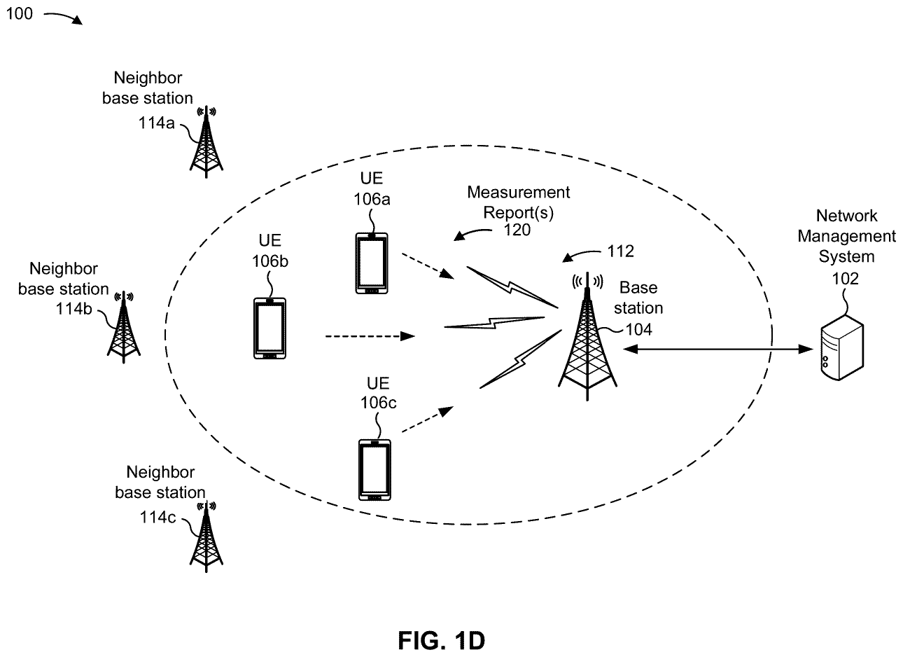

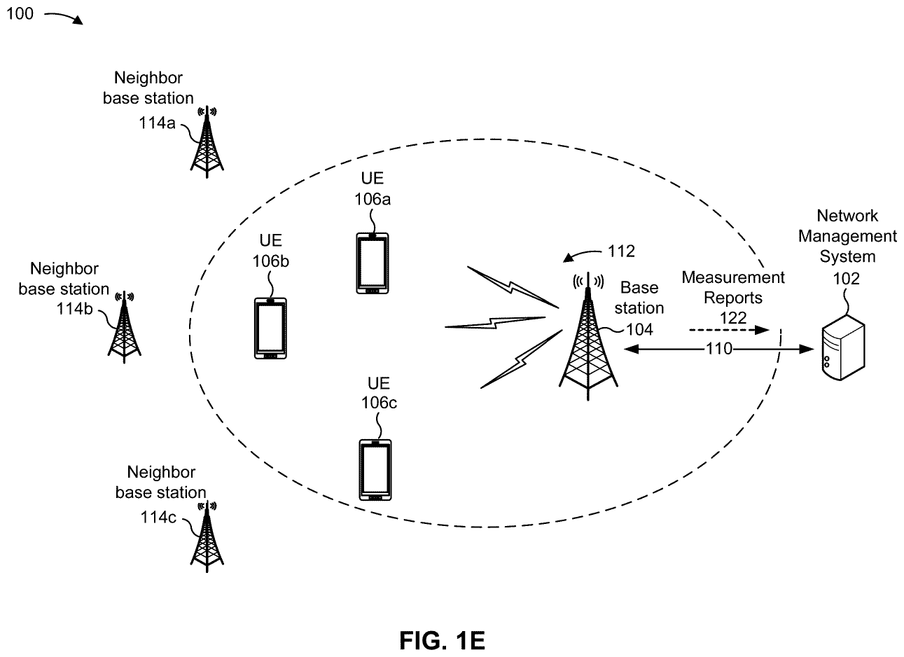

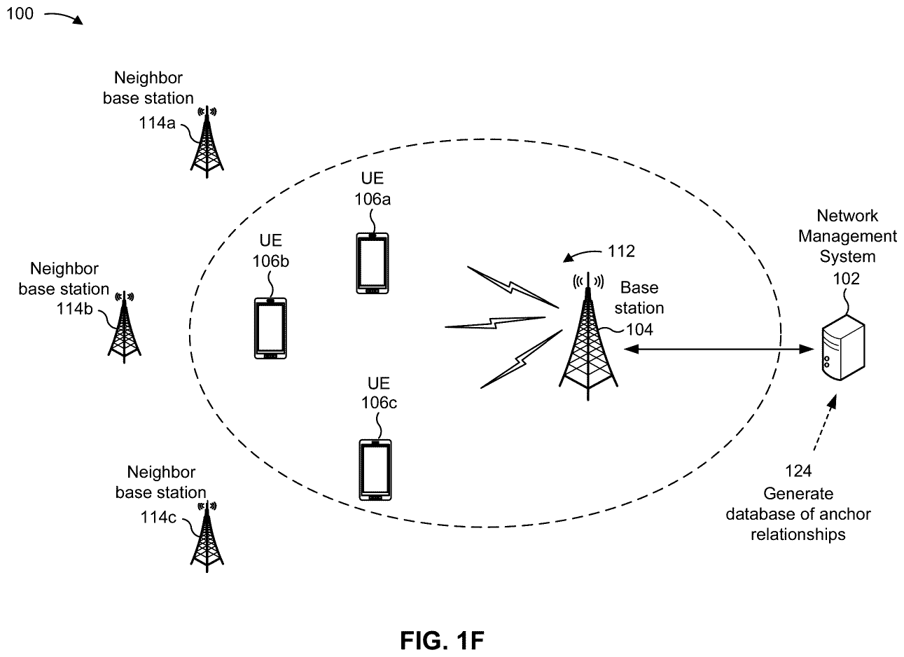

FIGS. 1A-1F are diagrams of an example implementation 100 associated with automated DC management within wireless networks, such as an LTE wireless network, a fifth generation (5G) wireless network, a sixth generation (6G) wireless network, or any combination thereof. As shown in FIGS. 1A-1F, example implementation 100 includes a network management system 102, a base station 104, and multiple UEs (shown as UE 106a, UE 106b, and UE 106c). These devices are described in more detail below in connection with FIGS. 1A-1F.

As shown by FIG. 1A, a connection 110 between a network management system 102 and a base station 104 may be established. Examples of types of connections between the network management system 102 and the base station 104 may include fiber optic connections, Ethernet connections, or wireless backhaul connections. For clarity, FIG. 1A shows the network management system 102 establishing the connection 110 with a single base station 104, but other examples may include the network management system 102 establishing respective connections with multiple base stations to enable the network management system 102 to oversee and coordinate DC management across various base stations. Additionally, or alternatively, the network management system 102 may communicate with the base station 104 using a secure connection 110, such as by using an Internet protocol security (IPsec) that provides a suite of protocols that are designed to ensure secure communication through Internet protocol (IP) networks through the use of authentication and/or encryption. The use of a secure connection may protect data that is exchanged between the network management system 102 and the base station 104 from unauthorized access and tampering, thus maintaining data integrity and confidentiality.

Additionally, or alternatively, the base station 104 may serve or communicate with one or more UEs (e.g., the UE 106a, the UE 106b, and the UE 106c) using one or more wireless connections 112. For instance, the base station 104 may establish a respective wireless connection with the UE 106a, UE 106b, and/or UE 106c by broadcasting a signal that the UEs may detect. Based at least in part on detecting the broadcast signal from the base station 104, a UE may transmit a connection request that the base station 104 authenticates and authorizes before establishing the wireless connection. In some cases, the base station 104 may continuously monitor a respective signal strength, a respective link quality, and/or other network conditions to maintain and optimize the wireless connections 112 to ensure stable and efficient communication with the UEs 106. Additionally, or alternatively, the network management system 102 may utilize the connection 110 to send configuration updates to the base station 104. For example, one or more configuration updates from the network management system 102 to the base station 104 may include changes in operational parameters to enhance network performance and connectivity. To illustrate, a configuration update may be triggered by increased network congestion, prompting adjustments in resource allocation and scheduling to improve data traffic handling and reduce latency for wireless connections 112. As another example, a configuration update may enable support for new frequency bands like C-band or mmWave to expand network capacity and coverage. A configuration updates may also implement new security protocols, ensuring that wireless connections 112 are secure and protected against potential threats. As one example, the base station 104 and the UEs 106 may use Transport Layer Security (TLS) to encrypt data that is transmitted between the base station 104 and the UEs 106. The base station 104 and/or the UEs 106 may use mutual authentication to ensure that both the sender and receiver are verified before any data exchange occurs. An example encryption algorithm may include Advanced Encryption Standard (AES) with 256-bit keys.

In some cases, the base station 104 may coordinate with one or more neighboring base stations (shown as neighboring base station 114a, neighboring base station 114b, and neighboring base station 114c) to optimize network performance and manage interference. For example, base station 104 and neighboring base stations 114 may implement coordinated scheduling to manage interference by synchronizing respective transmission and/or respective reception times within each respective cell to reduce signal overlap and improving overall network performance. As another example, the base station 104 and/or neighboring base stations 114 may use in dynamic frequency selection, where each base station continuously monitors the network environment and adjusts respective operating frequencies to minimize interference and optimize the use of available spectrum.

As shown by FIG. 1B, the network management system 102 may deploy one or more reporting configurations 116 to the base station 104. For example, the network management system 102 may specify a reporting interval, a metric type, or a frequency band for the UEs 106 to use when generating a measurement report. In some aspects, the reporting configuration 116 may specify (explicitly or implicitly) to generate a measurement metric that is associated with a neighboring base station (e.g., the neighboring base station 114a, neighboring base station 114b, and/or neighboring base station 114c), such as by including a first configuration for generating a measurement metric based at least in part on a carrier frequency of a neighboring base station or a second configuration for an interference level metric (e.g., for a UE that is operating within proximity to a neighboring base station). Additionally, or alternatively, the reporting configuration 116 may indicate a trigger event for generating and/or reporting a measurement report, such as a trigger event that is based at least in part on changes in signal strength, detection of new cell identities, or handover events between different cells. For instance, with regard to an EN-DC anchoring relationship, the reporting configuration may indicate a first measurement trigger event, that instructs the UE to search for an NR base station and, based at least in part on a signal quality of the NR cell meeting a specified threshold, trigger a measurement report (e.g., an event B1, where “B1” is a label specified by a communication standard). With regard to NR-DC, the reporting configuration may indicate a second measurement trigger event that instructs a UE that is connected to a first NR base station using a first frequency range to trigger measurement reporting for the metrics for a second NR base station that operates in a second frequency range (e.g., an event A4, where “A4” is a label specified by a communication standard). The reporting configuration 116 may indicate a threshold value that is associated with a trigger event. In some aspects, the network management system 102 may deploy customized reporting configurations to base station 104 that ensure that the reporting parameters align with information used by the network management system 102 to manage operation within a wireless network. As one example, a first customized reporting configuration may be based at least in part obtaining frequent and detailed measurement reports from each UE to monitor network performance. A second customized reporting configuration may be based at least in part on obtaining detailed interference level metrics from UEs operating near an edge of a cell.

Additionally, or alternatively, reporting configurations deployed by the network management system 102 may include specific parameters for different types of measurement reports. The ability to customize a reporting configuration enables the network management system 102 to target and obtain different network metrics effectively and based at least in part on current network needs (e.g., interference mitigation or performance optimizations). In some cases, the network management system 102 may periodically update the reporting configurations sent to the base station 104 to adapt to changing network conditions. Additionally, or alternatively, the network management system 102 may configure the base station 104 to collect, aggregate, and forward measurement reports from the UEs.

In some aspects, the network management system 102 may use a machine learning algorithm (e.g., an algorithm that enables computers to learn from and make predictions or decisions based on data) to select a reporting configuration. Examples of a machine learning algorithm include supervised learning algorithms like Random Forest or Support Vector Machines. For instance, machine learning algorithms may identify patterns and trends in network connections or historical data about the network connections, and use the trends to select a measurement reporting configuration to obtain more information. Other examples may include a Python™-based algorithm that analyzes the historical data or network connections to generate a measurement reporting configuration, or receives input (e.g., manual input) that indicates a measurement reporting configuration.

As shown by FIG. 1C, the base station 104 may transmit a reporting configuration 118 to the UEs 106a, 106b, and 106c using the wireless connections 112, and the reporting configuration 118 may be based at least in part on the reporting configuration 116 from the network management system 102. For example, the reporting configuration 118 may include one or more parameters that determine how often a UE (e.g., the UE 106a, the UE 106b, or the UE 106c) reports network-related metrics (e.g., periodically or a-periodically). In some aspects, the reporting configuration 118 may indicate a measurement metric type to generate, such as RSRP and RSRQ. Additionally, or alternatively, the reporting configuration 118 may include trigger thresholds for reporting a network-related metric, including a trigger threshold specified by the network management system 102 via the reporting configuration 116, resulting in a UE reporting a network-related metric as configured by the network management system 102 to facilitate network management. As another example, the reporting configuration 118 may include one or more trigger events for generating and/or reporting a measurement report, such as trigger events based at least in part on changes in a signal strength, detection of new cell identities, or handover events between different cells. In some cases, the base station 104 may broadcast the reporting configuration 116 to the UE 106a, the UE 106b, and/or the UE 106c, and in other cases, the base station 104 may unicast the reporting configuration 116 to each UE separately, or multicast the reporting configuration 116 to the UEs in a group message.

As shown by FIG. 1D, the UE 106a, the UE 106b, and/or the UE 106c may generate and transmit measurement reports 120 to the base station 104. For example, the UEs may respectively generate and measure one or more network-related metrics, such as signal strength and interference levels, and include the network-related metrics in the respective measurement report 120. In some aspects, the UE 106a, the UE 106b, and/or the UE 106c may generate a respective measurement report 120 based on the configured reporting intervals (e.g., a periodic reporting interval or an a-periodic reporting interval) indicated via the reporting configuration 118 and/or the reporting configuration 116. Additionally, or alternatively, the respective measurement report 120 generated by each UE may include additional metrics (e.g., autonomously or as directed by a reporting configuration 118), such as signal-to-noise ratio (SNR) and physical cell identity (PCI) to provide additional information about a current network condition that is associated with the measurement report. The UE 106a, the UE 106b, and/or the UE 106c may compute a measurement metric, and/or transmit a measurement report, periodically or in response to detecting a trigger event. In some cases, the UE 106a, the UE 106b, and/or the UE 106c may be configured to generate a metrics connection stability (e.g., a number of connection drops or interruptions).

As shown by FIG. 1E, the base station 104 may forward one or more measurement reports 122 to the network management system 102, where the measurement report(s) 122 may be based at least in part on the measurement report(s) 120 from the UEs 106. For example, the base station 104 may relay the measurement reports 120 generated by the UEs to the network management system 102, or may aggregate multiple measurement reports 120 received from multiple UEs before forwarding them to the network management system 102. Aggregating reports may reduce the amount of data transmitted and ensures that the network management system 102 receives a consolidated view of the network. Additionally, or alternatively, the base station 104 may generate the measurement reports 122 based at least in part on filtering the measurement reports 120 from the UEs 106 to remove redundant or irrelevant data before sending them to the network management system 102. Filtering reports ensures that only useful data is transmitted, reducing bandwidth usage. In some cases, the base station 104 may prioritize the processing and forwarding of measurement reports 122 based on network load and conditions. Prioritizing reports ensures that critical data is transmitted promptly even under high network load. Additionally, or alternatively, the base station 104 may use a secure channel to transmit measurement reports 122 to the network management system 102. Secure transmission ensures that the data remains confidential and tamper-proof. While FIG. 1E shows the network management system 102 receiving the measurement report 122 from a single base station 104, other examples may include the network management system 102 receiving respective measurement reports 122 from multiple base stations, resulting in the network management system 102 receiving information that provides a comprehensive view of the network and network conditions.

As shown by reference number 124 with regard to FIG. 1F, the network management system 102 may generate a database of anchor relationships based on one or more received measurement reports 122. To illustrate, based at least in part on receiving the measurement reports 122, the network management system 102 may preprocesses the data to filter out any noise or redundant information. Example preprocessing may include statistical methods such as moving averages or median filters to smooth the data. The network management system 102 may analyze the measurement reports 122 to identify optimal anchor relationships between the base station 104 and one of the neighboring base stations 114 to increase data throughput and/or reduce data transfer latencies in DC within the network. For instance, the network management system 102 may identify a neighboring base station associated with a lower interference level metric relative to other neighboring base stations to the base station 104. To illustrate, the network management system 102 may extract data from the preprocessed measurement reports 122 and feed the extracted data into a decision-making algorithm, such as a Python™-based algorithm that evaluates input data using a rule-based approach to create a baseline set of anchoring relationships, or update existing anchoring relationships. For instance, based at least in part on the RSRP of a neighboring base station being consistently higher than a predefined threshold, the decision-making algorithm may mark the neighboring base station as a potential anchor (e.g., in the anchoring relationship information). As another example, a decision-making algorithm may be implemented using a machine learning algorithm. Example machine learning algorithms may include as supervised learning algorithms like Random Forest or Support Vector Machines that may be trained (e.g., using historical data of network conditions and performance metrics) to predict the most efficient anchoring relationships by analyzing complex patterns or trends in the data. The predicted anchoring relationships may be validated against real-time data to ensure an accuracy and/or an efficiency of the predicted anchoring relationships.

In some aspects, the network management system 102 may create a database of anchor relationships based on a combination of historical data (e.g., historical measurement reports) and the measurement reports 122. Combining historical data and real-time measurement result may result in a more accurate and reliable basis for anchor relationship decisions, resulting in DC within the network with stable connections, increased data throughput, and reduced data transfer latency.

In some cases, the network management system 102 may dynamically update anchor relationships based on receiving additional measurement report from the UEs 106. Dynamic updates ensure that the anchor relationships remain relevant and/or optimal as network conditions change. Additionally, or alternatively, the network management system 102 may distribute the generated anchor relationships to relevant base stations to use in establishing DC, resulting in more optimal configuration for DC management, increased resource efficiency, increased data throughput, and reduced data transfer latency. For instance, during high network congestion, the network management system 102 may dynamically adjusts one or more anchoring relationships based on real-time data (e.g., real-time measurement reports). To illustrate, based at least in part on a particular base station experiencing a sudden spike in traffic, the network management system 102 may re-evaluate one or more anchoring relationships and/or may direct the particular base station to offload one or more UEs to neighboring base stations with lower traffic.

The continuous and automated interaction between the network management system 102, the base station 104, and the UEs 106 may be referred to as a closed-loop mechanism based insofar as the system of devices continuously collect real-time measurement data from the UEs, process the real-time measurement data to update and optimize anchoring relationships (e.g., by way of the anchoring relationship information stored in a data structure) between cells, and feedback the adjustments to the base stations for implementation, thereby ensuring an ongoing cycle of monitoring and improvement in DC configurations. “Closed-loop mechanism” may denote a system that continuously collects, processes, and uses real-time data (e.g., measurement reports) to make adjustments that optimize performance, such as an ongoing cycle of monitoring and improving DC configurations and/or anchoring relationships based on real-time measurements from UEs. Additionally, or alternatively, the network management system may configure (e.g., by manual input by a network operator or automatically) what may trigger a UE to periodically transmit measurement reports and/or what information is included in the measurement reports to obtain relevant information. The closed-loop mechanism may reduce manual intervention, improve the accuracy and responsiveness of network adjustments, and ensures more efficient use of network resources, leading to better overall network performance.

In some cases, the network management system 102 may validate an efficiency of an anchoring relationship. For example, the network management system 102 may monitor a usage of an automated anchoring relationship (e.g., dynamically generated using one or more measurement report) and a success rate of the automated anchoring relationship. To illustrate, the network management system 102 may track one or more metrics that are associated with an automated anchoring relationship, such as a frequency of established dual connectivity links that are based at least in part on the automated anchoring relationship, a data throughput associated with an automated anchoring relationship, a connection stability associated with the automated anchoring relationship, and a success rate of handovers involving new anchoring relationships. By analyzing these metrics, the network management system 102 may validate whether an automated anchoring relationship is utilized and/or whether the automated anchoring relationship increases a quality network performance (e.g., increased data throughput, increased connection stability, and an increased success rate of handovers involving a new anchoring relationship).

Additionally, or alternatively, the network management system 102 may generate the anchoring relationship information without using NCGI information. To illustrate, frequency range 2 (FR2) refers to frequencies from about 24.25 GHz to about 52.6 GHz, and may be used for 5G NR communications. Some devices that support FR2 millimeter waves (e.g., FR2 devices) may not support NCGI reporting that may break automated neighbor relation (ANR) mechanisms that rely on NCGI. Based at least in part on using PCI and/or a network topology, the network management system may derive anchoring relationships as described above, including using measurement reports from FR2 devices that do not support NCGI reporting.

For secure communication protocols, the network management system 102 may utilize Transport Layer Security (TLS) to encrypt data transmitted between the base stations and the UEs. The system employs mutual authentication, ensuring that both the sender and receiver are verified before any data exchange occurs. The encryption algorithms used include Advanced Encryption Standard (AES) with 256-bit keys, providing robust security against potential cyber threats.

In practical scenarios, such as during high network congestion, the network management system 102 may dynamically adjust an anchor relationship based on real-time data. For example, if a particular base station experiences a sudden spike in traffic, the network management system 102 may re-evaluate an associated anchor relationship and may offload some UEs to neighboring base stations with lower traffic. This dynamic adjustment may be facilitated by algorithms that adapt to changing network conditions, ensuring optimal performance and resource utilization.

The network management system 102 may also modify the closed-loop mechanism based at least in part on user input (e.g., from a network operator), such as modifying a reporting configuration. For example, a network operator may enter user input that specifies whether an anchoring relationship is a one-to-one anchoring relationship or a one-to-many anchoring relationship, resulting in increased flexibility in managing DC configurations. Additionally, or alternatively, support for modifying the closed-loop mechanism via user input enables the network operator to customize the reporting procedure (e.g., a periodicity, a number of returned metrics, a type of returned metric, or a trigger event) and to tailor a scope of the automated anchoring relationship generation process. To illustrate, based at least in part in input to the network management system 102, a network operator may configure the network management system 102 and/or the closed-loop mechanism to query and update anchoring relationships at configurable intervals, such as by configuring the closed-loop mechanism to update the anchoring relationships (e.g., via measurement reports) hourly, daily, every six hours, or weekly, depending on network conditions and operational requirements. Additionally, or alternatively, a network operator may tailor a geographical scope of the automation, such as by configuring the automation of anchoring relationships to entire markets, specific regions, or targeted areas (e.g., event venues). The ability to customize the network management system 102 and/or the closed-loop mechanism enables the network operator to adapt the closed-loop system, and the efficacy of the generated anchoring relationships, to unique needs and dynamics of different network environments, resulting in optimized performance and resource utilization. By ensuring that the anchor relationships remain up to date with the current network conditions using frequent updates to the anchoring relationships, the closed-loop mechanism may increase the reliability of connectivity and reduce the risk of customer complaints.

In some aspects, the network operator may input, or the network management system 102 may be configured with, one or more control conditions or control boundaries, such as a control condition that specifies a maximum number of neighbor relationships that may be created, or a second control condition that specifies a maximum frequency of querying data. These control conditions may balance preventing overloading the network with maintaining an accuracy of the anchoring relationships that are generated by the network management system 102.

As indicated above, FIGS. 1A-1F are provided as an example. Other examples may differ from what is described with regard to FIGS. 1A-1F.

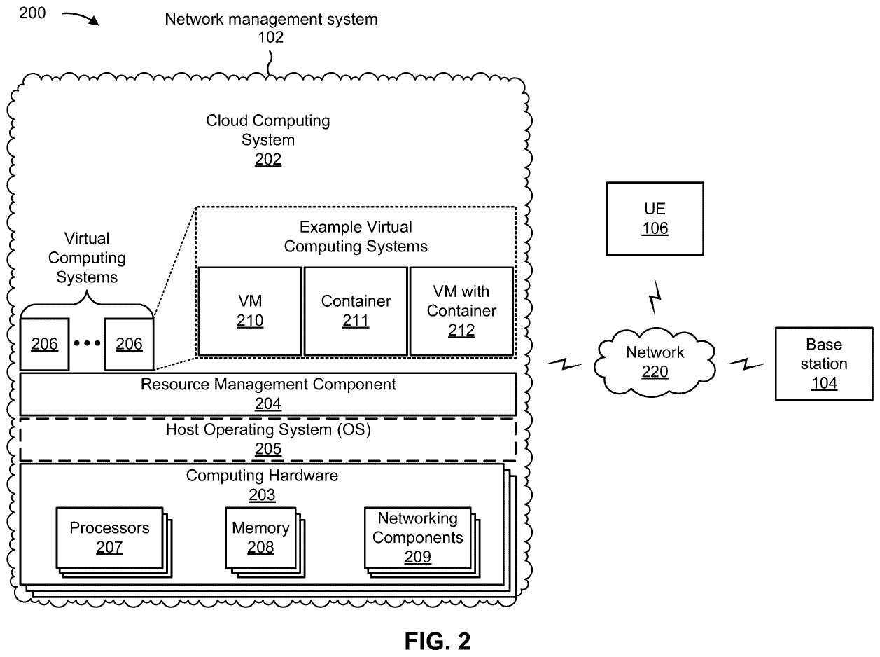

FIG. 2 is a diagram of an example environment 200 in which systems and/or methods described herein may be implemented. As shown in FIG. 2, environment 200 may include a network management system 102, which may include one or more elements of and/or may execute within a cloud computing system 202. The cloud computing system 202 may include one or more elements 203-212, as described in more detail below. As further shown in FIG. 2, environment 200 may include a network 220, a base station 104, and/or a UE 106. Devices and/or elements of environment 200 may interconnect via wired connections and/or wireless connections.

The base station 104 may support, for example, a cellular radio access technology (RAT). The base station 104 may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the UE 106. The base station 104 may transfer traffic between the UE 106 (e.g., using a cellular RAT), one or more base stations (e.g., using a wireless interface or a backhaul interface, such as a wired backhaul interface), and/or a core network. The base station 104 may provide one or more cells that cover geographic areas.

In some implementations, the base station 104 may perform scheduling and/or resource management for the UE 106 covered by the base station 104 (e.g., the UE 106 covered by a cell provided by the base station 104). In some implementations, the base station 104 may be controlled or coordinated by a network controller, which may perform load balancing, network-level configuration, and/or other operations. The network controller may communicate with the base station 104 via a wireless or wireline backhaul. In some implementations, the base station 104 may include a network controller, a self-organizing network (SON) module or component, or a similar module or component. In other words, the base station 104 may perform network control, scheduling, and/or network management functions (e.g., for uplink, downlink, and/or sidelink communications of the UE 106 covered by the base station 104).

The UE 106 includes one or more devices capable of receiving, generating, storing, processing, and/or providing information, such as information described herein. For example, the UE 106 may include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

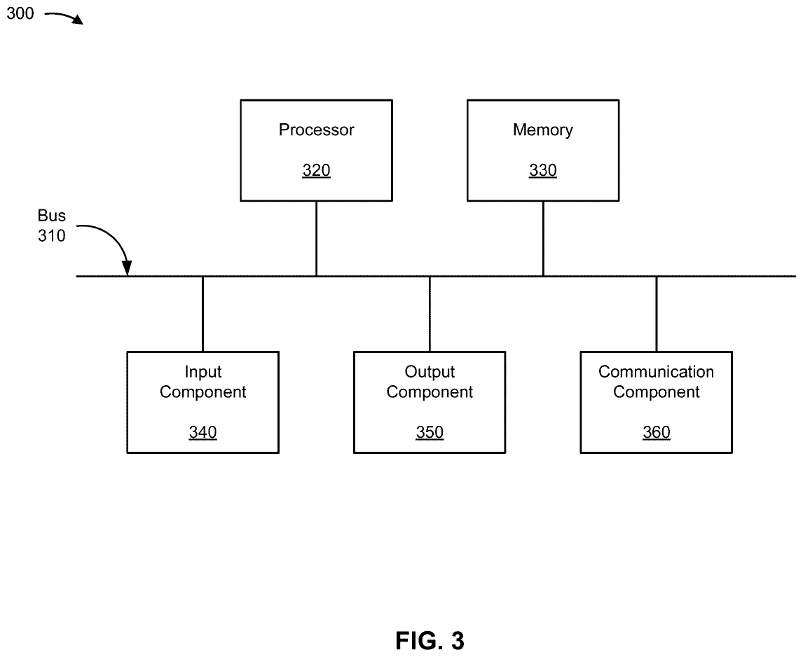

Although the network management system 102 may include one or more elements 203-212 of the cloud computing system 202, may execute within the cloud computing system 202, and/or may be hosted within the cloud computing system 202, in some implementations, the network management system 102 may not be cloud-based (e.g., may be implemented outside of a cloud computing system) or may be partially cloud-based. For example, the network management system 102 may include one or more devices that are not part of the cloud computing system 202, such as device 300 of FIG. 3, which may include a standalone server or another type of computing device. The network management system 102 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with automating anchor relationship determination in a wireless network. The device 300 corresponds to one or more of a network management system 102, a base station 104, and/or a UE 106. In some implementation, a network management system 102, a base station 104, and/or a UE 106 include one or more devices 300 and/or one or more components of the device 300. In the example shown in FIG. 3, the device 300 includes a bus 310, a processor 320, a memory 330, an input component 340, an output component 350, and/or a communication component 360.

The bus 310 includes one or more components that enable wired and/or wireless communication among the components of the device 300. The bus 310 couples together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 includes a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory, such as random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). In some implementations, the memory 330 is a non-transitory computer-readable medium. The memory 330 stores information, one or more instructions, and/or software (e.g., one or more software applications) related to the operation of the device 300. In some implementations, the memory 330 includes one or more memories that are coupled (e.g., communicatively coupled) to one or more processors (e.g., processor 320), such as via the bus 310. Communicative coupling between a processor 320 and a memory 330 enables the processor 320 to read and/or process information stored in the memory 330 and/or to store information in the memory 330.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

In some implementations, the device 300 performs one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

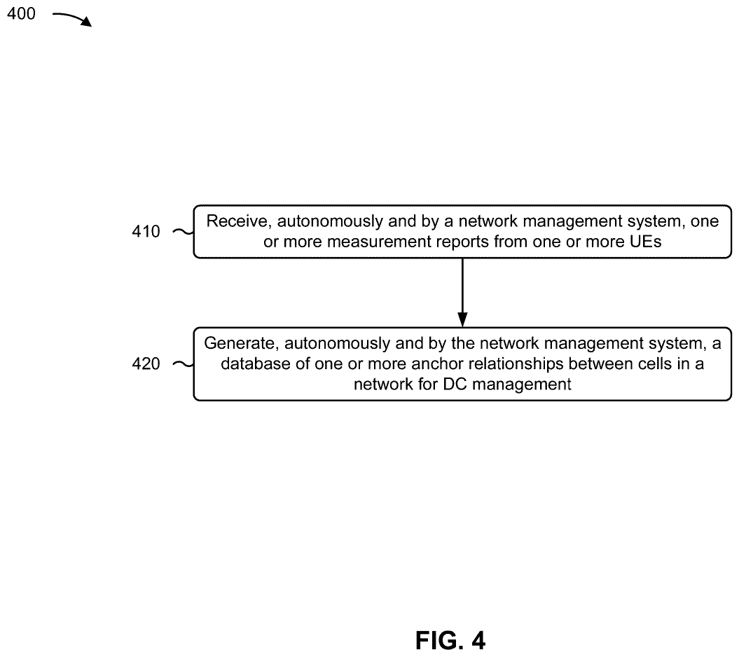

FIG. 4 is a flowchart of an example process 400 associated with automating anchor relationship determination in wireless networks. In some implementations, one or more process blocks of FIG. 4 may be performed by a network management system (e.g., a network management system 102 or a device 300). In some implementations, one or more process blocks of FIG. 4 may be performed by another device or a group of devices separate from or including the network management system, such as a base station (e.g., base station 104), and/or a UE (e.g., a UE 106). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving one or more measurement reports from one or more UEs, where each measurement report of the one or more measurement reports includes one or more metrics that characterize a network (block 410). For example, the network management system may receive one or more measurement reports from one or more UEs, and each measurement report may include one or more metrics that characterize a network, as described above. As one example, the one or more measurement reports may include one of an RSRP metric, an RSRQ metric, or an interference level metric. Alternatively, or additionally, a measurement report may include a PCI. Receiving the one or more measurement reports may include receiving the one or more measurement reports periodically according to a predetermined schedule (e.g., configured by a network operator or configured by the network management system). Additionally, or alternatively, receiving the one or more measurement reports may include receiving the one or more measurement reports a-periodically (e.g., based on a trigger event).

As further shown in FIG. 4, process 400 may include generating a data structure of one or more anchor relationships between cells in the network for DC, the one or more anchor relationships based at least in part on the one or more measurement reports (block 420). For example, the network management system may generate a data structure (e.g., a database) of one or more anchor relationships between cells in the network for DC, and the one or more anchor relationships may be based at least in part on one or more measurement reports, as described above. That is, the network management system may generate and store anchor relationship information. As one example, generating the data structure of the one or more anchor relationships may include deriving one or more connectivity parameters using the one or more measurement reports, and storing the one or more connectivity parameters in the data structure. Example connectivity parameters and/or information stored in the data structure may include any combination of a DC type (e.g., EN-DC or NR-DC), a cell reselection threshold, a load balancing parameter, a security management parameter, a split radio, PCI, one or more measurement metrics (e.g., RSRP and/or RSRQ), a latitude distance between two base stations, a longitude distance between two base stations, a serving ENM, or a market ID. Alternatively, or additionally, the network management system may obtain or derive, from the measurement reports, collision information (e.g., PCI collision information) that indicates a less favorable anchoring relationship, a less efficient anchoring relationship, or inaccurate anchoring relationship information. As one example, a measurement report from a UE may be based at least in part on a PCI “X” that the UE reports is associated with a distance “Y”. However, information currently existing in the data structure may indicate that PCI “X” is configured to be at a distance “Z” that is further away than distance “Y” as reported by the UE. Based at least in part on the discrepancy, the network management system may determine the current anchoring relationship information, the anchoring relationship information indicated by the measurement report, or a combination of the two, is inaccurate and may trigger additional measurement reporting to update the anchoring relationship information.

In some cases, the network management system may generate the data structure of anchor relationships without using NCGI information. Additionally, or alternatively, a measurement report may include one or more metrics that are based at least in part on an FR2 millimeter wave deployment in a network, the network management system may generate the data structure of the anchor relationships using the metric(s) that are based at least in part on the FR2 millimeter wave deployment.

In some implementations, process 400 includes utilizing the data structure to manage DC in the network. For example, the network management system may deploy one or more anchor relationships in the data structure (e.g., anchor relationship information) to one or more cells in the network to manage the DC in the network.

In some implementations, process 400 includes receiving one or more additional measurement reports from one or more UEs, and updating the data structure of the one or more anchor relationships based on one or more additional measurement reports. Alternatively, or additionally, process 400 includes monitoring a utilization of the one or more anchor relationships in the data structure, and adjusting the one or more anchor relationships based on the utilization.

In some implementations, process 400 includes receiving input that specifies a reporting configuration for the one or more measurement reports, and deploying the reporting configuration to one or more cells in the network.

In some implementations, process 400 includes generating an efficiency metric for the one or more anchor relationships based at least in part on at least one of traffic data (e.g., an amount of traffic or a duration of traffic that satisfies a threshold) or usage data (e.g., user data or control data). Example efficiency metrics may include throughput efficiency, radio resource utilization, a packet loss rate, a retransmission rate, an end-to-end data transfer latency, a handover success rate, a handover failure rate, or an anchor node switching frequency, and the efficiency metrics may be based at least in part on the traffic data and/or the usage data.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving one or more measurement reports from one or more user equipments (UEs), each measurement report of the one or more measurement reports including one or more metrics that characterize a network;
generating, a data structure of one or more anchor relationships between cells in the network for dual connectivity (DC), the one or more anchor relationships based at least in part on the one or more measurement reports; and
utilizing the data structure to manage the DC in the network.

2. The method of claim 1, further comprising:
receiving one or more additional measurement reports from the one or more UEs; and
updating the data structure of the one or more anchor relationships based on the one or more additional measurement reports.

3. The method of claim 1, wherein the one or more measurement reports comprises one of:
a reference signal received power (RSRP) metric,
a reference signal received quality (RSRQ) metric,
an interference level metric, or
a physical cell identity (PCI).

4. The method of claim 1, wherein generating the data structure of the one or more anchor relationships comprises:
deriving one or more connectivity parameters using the one or more measurement reports; and
storing the one or more connectivity parameters in the data structure.

5. The method of claim 4, wherein the one or more connectivity parameters comprises at least one of:
one or more evolved universal terrestrial radio access network (E-UTRAN) New Radio dual connectivity (EN-DC) parameters, or
one or more New Radio dual connectivity (NR-DC) parameters.

6. The method of claim 1, further comprising:
monitoring a utilization of the one or more anchor relationships in the data structure; and
adjusting the one or more anchor relationships based on the utilization.

7. The method of claim 1, wherein the one or more measurement reports are received periodically according to a predetermined schedule.

8. A device, comprising:
one or more processors configured to:
receive one or more measurement reports from one or more user equipments (UEs), each measurement report of the one or more measurement reports including one or more metrics that characterize a network;
generate a data structure of one or more anchor relationships between cells in the network for dual connectivity (DC), the one or more anchor relationships based at least in part on the one or more measurement reports; and
utilize the data structure to manage the DC in the network.

9. The device of claim 8, wherein the one or more processors, to generate the data structure of the one or more anchor relationships, are configured to:
generate the data structure of the one or more anchor relationships without using New Radio cell global identity (NCGI).

10. The device of claim 8, wherein the one or more processors are further configured to:
deploy the one or more anchor relationships in the data structure to one or more cells of the cells in the network to manage the DC in the network.

11. The device of claim 8, wherein the one or more processors are further configured to:
receive input that specifies a reporting configuration for the one or more measurement reports; and
deploy the reporting configuration to one or more cells of the cells in the network.

12. The device of claim 8, wherein the one or more metrics are based at least in part on a specific frequency range deployment in the network, and
wherein the one or more processors, to generate the data structure of the one or more anchor relationships, are configured to:
generate the data structure of the one or more anchor relationships based at least in part on the one or more metrics that are based at least in part on the specific frequency range deployment.

13. The device of claim 8, wherein the one or more processors are further configured to:
receive one or more additional measurement reports; and
update the data structure of the one or more anchor relationships using the one or more additional measurement reports.

14. The device of claim 8, wherein the one or more processors are further configured to:
generate an efficiency metric for the one or more anchor relationships based at least in part on at least one of:
traffic data, or
usage data.

15. A non-transitory computer-readable medium storing a set of instructions, the set of instructions comprising:
one or more instructions that, when executed by one or more processors of a device, cause the device to:
receive one or more measurement reports from one or more user equipments (UEs), each measurement report of the one or more measurement reports including one or more metrics that characterize a network;
generate a data structure of one or more anchor relationships between cells in the network for dual connectivity (DC) management, the one or more anchor relationships based at least in part on the one or more measurement reports; and
utilize the data structure to manage the DC in the network.

16. The non-transitory computer-readable medium of claim 15, wherein the one or more instructions further cause the device to:
receive one or more additional measurement reports from the one or more UEs; and
update the data structure of the one or more anchor relationships based on the one or more additional measurement reports.

17. The non-transitory computer-readable medium of claim 15, wherein the one or more instructions, that cause the device to generate the data structure of the one or more anchor relationships, cause the device to:
derive one or more connectivity parameters using the one or more measurement reports; and
store the one or more connectivity parameters as at least part of the data structure.

18. The non-transitory computer-readable medium of claim 15, wherein the one or more instructions, that cause the device to generate the data structure of the one or more anchor relationships, further cause the device to:
generate the data structure of the one or more anchor relationships without using New Radio cell global identity (NCGI).

19. The non-transitory computer-readable medium of claim 15, wherein the one or more instructions further cause the device to:
deploy the one or more anchor relationships in the data structure to one or more cells of the cells in the network to manage the DC in the network.

20. The non-transitory computer-readable medium of claim 15, wherein the one or more instructions further cause the device to:
generate an efficiency metric for the one or more anchor relationships based at least in part on at least one of:
traffic data, or
usage data.
